(19) United States
(12) Patent Application Publication
(10) Pub. No.: US 2016/0084087 A1
(43) Pub. Date: Mar. 24, 2016

(54) ROTOR IN A TURBINE ENGINE COUPLED TO PROVIDE INDIVIDUAL AND SEPARATE ACCESS TO RESPECTIVE ASSEMBLIES OF COMPRESSOR AND TURBINE DISKS

(71) Applicant: SIEMENS ENERGY, INC., Orlando, FL (US)

(72) Inventors: Brian D. Nereim, Winter Springs, FL (US); Piyush Sane, Orlando, FL (US); Yevgeniy P. Shteyman, West Palm Beach, FL (US)

(73) Assignee: Siemens Energy, Inc., Orlando, FL (US)

(21) Appl. No.: 14/890,432

(22) PCT Filed: May 5, 2014
(86) PCT No.: PCT/US14/36803

§ 371 Date: Nov. 11, 2015

Related U.S. Application Data
(60) Provisional application No. 61/823,185, filed on May 14, 2013.

(51) Int. Cl. F01D 5/06

(52) U.S. Cl. CPC F01D 5/063; F05D 2220/32

(57) ABSTRACT

A rotor for a turbine engine. The rotor may include an assembly of axially-bolted compressor disks (14). A compressor torque tube (30) is connected to the assembly of compressor disks (14). The rotor may further include an assembly of axially-bolted turbine disks (22). A turbine torque tube (32) is axially connected to the assembly of turbine disks (22). A marriage coupling (34) is arranged to interconnect the respective torque tubes (30, 32). The marriage coupling includes a flange joint arranged to decouple the compressor torque tube or the turbine torque tube so that individual and separate access can be provided to the respective assemblies of compressor disks and turbine disks.

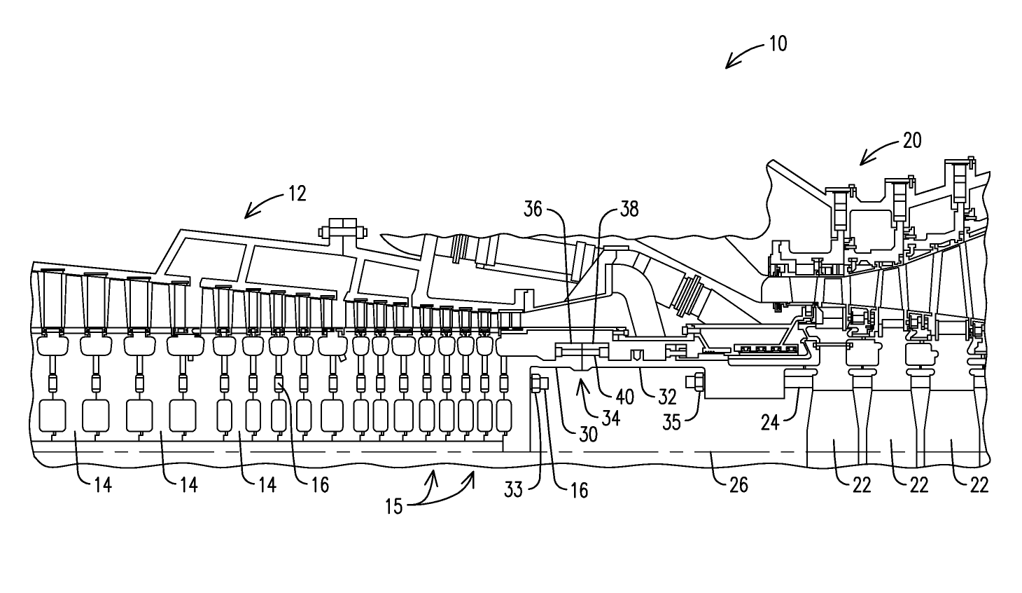

This application claims benefit of the May 14, 2013 filing date of U.S. provisional application 61/823,185 which is incorporated by reference herein.

### FIELD OF THE INVENTION

The present invention is generally related to rotor structures for a turbine engine, and, more particularly, to a rotor structure coupled to provide individual and separate access to respective assemblies of compressor and turbine disks of a turbine engine.

### BACKGROUND OF THE INVENTION

Turbo-machinery, such as gas turbine engines, generally includes a compressor section and a turbine section. A rotor generally extends axially through the sections of the turbine engine and includes respective structures for supporting rotatable blades in the compressor and turbine sections. For example, a portion of the rotor extending through the turbine section may comprise a plurality of turbine disks adapted to support a plurality of turbine blades. Similarly, a portion of the rotor extending through the compressor section may comprise a plurality of compressor disks adapted to support a plurality of compressor blades. U.S. Pat. Nos. 5,927,157 and 8,465,259 disclose rotor constructions in a gas turbine engine.

### BRIEF DESCRIPTION OF THE DRAWINGS

The sole FIGURE is a longitudinal cross-sectional view of a turbine engine including a compressor section and a turbine section.

### DETAILED DESCRIPTION OF THE INVENTION

In the following detailed description, various specific details are set forth in order to provide a thorough understanding of such embodiments. However, those skilled in the art will understand that embodiments of the present invention may be practiced without these specific details, that the present invention is not limited to the depicted embodiments, and that the present invention may be practiced in a variety of alternative embodiments. In other instances, methods, procedures, and components, which would be well-understood by one skilled in the art have not been described in detail to avoid unnecessary and burdensome explanation.

Furthermore, various operations may be described as multiple discrete steps performed in a manner that is helpful for understanding embodiments of the present invention. However, the order of description should not be construed as to imply that these operations need be performed in the order they are presented, nor that they are even order dependent unless otherwise so described. Moreover, repeated usage of the phrase “in one embodiment” does not necessarily refer to the same embodiment, although it may. Lastly, the terms “comprising”, “including”, “having”, and the like, as used in the present application, are intended to be synonymous unless otherwise indicated.

The FIGURE illustrates a non-limiting embodiment of a turbine engine 10 that can benefit from aspects of the present invention. Turbine engine 10 may be a gas turbine engine for generating electricity. Turbine engine 10 includes a compressor section 12 that comprises an assembly of compressor disks 14 that forms a portion of a rotor 15. A first set of spindle bolts 16 (only one shown) may be used to axially-bolt the assembly of compressor disks 14.

As will be appreciated by those skilled in the art, compressed air from compressor section 12 is directed to a combustor where the air is mixed with fuel and ignited to produce hot working gases for generating power in a turbine section 20 that comprises an assembly of turbine disks 22. A second set of spindle bolts 24 (only one shown) may be used to axially-bolt the assembly of turbine disks 22. Spindle bolts 16, 24 are respectively disposed circumferentially about a rotational axis 26 of the compressor and turbine disks.

In one non-limiting embodiment, a compressor torque tube 30 is connected to the assembly of compressor disks 14, and a turbine torque 32 is connected to the assembly of turbine disks 22. Spindle bolts 16 include retaining nuts 33 engaged against a wall of compressor torque tube 30. Similarly, spindle bolts 24 include retaining nuts 35 engaged against a wall of turbine torque tube 32. A marriage coupling 34 is arranged to interconnect the respective torque tubes 30, 32. In one non-limiting embodiment, marriage coupling 34 defines a flange joint comprising a first radially extending flange 36 disposed at an end of compressor torque tube 30 and a second radially extending flange 38 disposed at an end of turbine torque tube 32. Marriage coupling 34 further comprises an affixing structure 40, such as bolt and nuts, or a clamping structure, to detachably interconnect to one another first and second flanges 36, 38. This allows decoupling compressor torque tube 30 or turbine torque tube 32 so that individual and separate access can be provided to the respective assemblies of compressor disks and turbine disks 14, 22.

In operation, aspects of the present invention, such as the axially-bolted assemblies of compressor disks and turbine disks 14, 22 result in a structure that is substantially more thermally compliant when a thermal gradient is present, which can be formed in normal operation during transient operational conditions, such as during conditions involving relatively fast starting times for the turbine engine. Moreover, the individual and separate access that can be provided to the respective assemblies of compressor disks and turbine disks 14, 22 provides a significant advantage during servicing operations where just the assembly of compressor disks or just the assembly of turbine disks can be separately de-stacked compared to previous structural arrangements that involve burdensome de-stacking of both disk assemblies regardless of whether the servicing involves just one of the disk assemblies.

While various embodiments of the present invention have been shown and described herein, it will be apparent that such embodiments are provided by way of example only. Numerous variations, changes and substitutions may be made without departing from the invention herein. Accordingly, it is intended that the invention be limited only by the spirit and scope of the appended claims.

The invention claimed is:

1. A rotor comprising:
an assembly of axially-bolted compressor disks;
a compressor torque tube connected to the assembly of compressor disks;
an assembly of axially-bolted turbine disks;
a turbine torque tube axially connected to the assembly of turbine disks; and
a marriage coupling arranged to interconnect the compressor and turbine torque tubes, the marriage coupling including a flange joint arranged to decouple the compressor torque tube from the turbine torque tube so that individual and separate access can be provided to the respective assemblies of compressor disks and turbine disks.

2. The rotor of claim 1, comprising a first set of spindle bolts to axially-bolt the assembly of compressor disks.

3. The rotor of claim 2, comprising a second set of spindle bolts to axially-bolt the assembly of turbine disks.

4. The rotor of claim 1, wherein the flange joint comprises a first radially extending flange disposed at an end of the compressor torque tube.

5. The rotor of claim 4, wherein the flange joint comprises a second radially extending flange disposed at an end of the turbine torque tube.

6. The rotor of claim 5, wherein the marriage coupling further comprises affixing structure to detachably interconnect to one another the first and second flanges.

7. A turbine engine comprising the rotor of claim 1.

8. A turbine engine comprising:
a compressor section comprising an assembly of compressor disks;
a first set of spindle bolts to axially-bolt the assembly of compressor disks;
a compressor torque tube connected to the assembly of compressor disks;
a turbine section comprising an assembly of turbine disks;
a second set of spindle bolts to axially-bolt the assembly of turbine disks;
a turbine torque tube axially connected to the assembly of turbine disks; and
a marriage coupling arranged to interconnect the respective torque tubes, the marriage coupling including a flange joint arranged to decouple the compressor torque tube or the turbine torque tube so that individual and separate access can be provided to the respective assemblies of compressor disks and turbine disks.

9. The turbine engine of claim 8, wherein the flange joint comprises a first radially extending flange disposed at an end of the compressor torque tube, and a second radially extending flange disposed at an end of the turbine torque tube.

10. The turbine engine of claim 9, wherein the marriage coupling further comprises an affixing structure to detachably interconnect to one another the first and second flanges.
